(19) United States
(12) Patent Application Publication
(10) Pub. No.: US 2025/0208869 A1
(43) Pub. Date: Jun. 26, 2025

(54) DEVICE, SYSTEM, AND METHOD FOR CONSOLIDATING ELIGIBLE VECTOR INSTRUCTIONS

(71) Applicant: Advanced Micro Devices, Inc., Santa Clara, CA (US)

(72) Inventors: Heather Lynn Hanson, Austin, TX (US); Yasuko Eckert, Bellevue, WA (US); Onur Kayiran, Rochester, NY (US); Gabriel H. Loh, Bellevue, WA (US); Travis Boraten, Austin, TX (US); Bradford Beckmann, Bellevue, WA (US)

(73) Assignee: Advanced Micro Devices, Inc., Santa Clara, CA (US)

(21) Appl. No.: 18/395,093

(22) Filed: Dec. 22, 2023

(51) Int. Cl. G06F 9/30

(52) U.S. Cl. CPC G06F 9/30038

(57) ABSTRACT

A disclosed method for consolidating eligible vector instructions can include detecting a plurality of vector instructions within a queue of an integrated circuit. The method can also include consolidating the plurality of vector instructions into a single vector instruction based at least in part on the plurality of instructions satisfying one or more criteria. The method can further include forwarding the single vector instruction through a pipeline of the integrated circuit. Various other devices, systems, and methods are also disclosed.

### BACKGROUND

Processors often include a queue that feeds instructions through a pipeline for execution. Unfortunately, as the number of instructions fed through the pipeline increases, so too does the power consumption of the processors. Additionally or alternatively, as the number of instructions fed through the pipeline increases, the performance of the processors can potentially decrease. The instant disclosure, therefore, identifies and addresses a need for additional and improved devices, systems, and methods for consolidating eligible instructions before they pass through the pipeline.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram of an exemplary computing device that consolidates eligible vector instructions according to one or more embodiments of this disclosure.

FIG. 2 is a block diagram of an additional exemplary system that consolidates eligible vector instructions according to one or more embodiments of this disclosure.

FIG. 3 is an illustration of exemplary vector instructions that are eligible for consolidation according to one or more embodiments of this disclosure.

FIG. 4 is a block diagram of an exemplary implementation of certain features for identifying eligible vector instructions according to one or more embodiments of this disclosure.

FIG. 5 is a block diagram of an exemplary implementation of certain features for identifying eligible vector instructions according to one or more embodiments of this disclosure.

FIG. 6 is a block diagram of an exemplary fusion unit capable of consolidating eligible vector instructions according to one or more embodiments of this disclosure.

FIG. 7 is a flowchart of an exemplary method for consolidating eligible vector instructions according to one or more embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

The present disclosure describes various devices, systems, and methods for consolidating eligible vector instructions. One example of vector instructions that can be eligible for consolidation is vector micro-operations (also commonly referred to as micro-ops) that derive from larger instructions. As will be explained in greater detail below, the various devices, systems, and/or methods described herein can provide various benefits and/or advantages over certain traditional implementations of processors and/or cores. For example, the various devices, systems, and/or methods described herein can increase, optimize, and/or maximize the efficiency of processor pipelines by reducing the number of vector instructions that pass through the processor pipelines, thereby decreasing the amount of power consumed by the processors.

By reducing the number of vector instructions that pass through the processor pipelines, these devices, systems, and/or methods can also mitigate, alleviate, and/or eliminate pipeline bottlenecks, thereby improving performance. Additionally or alternatively, these devices, systems, and/or methods can increase the effective capacity of instruction storage structures (e.g., micro-operation caches, scheduler queues, etc.), increase the effective instruction dispatch rate, increase the effective instruction issue rate, and/or increase the effective retirement and/or commit rate.

In some examples, a processor can include and/or represent a set of cores that are each equipped with a pipeline and a queue that maintains and/or collects vector micro-operations for selection by a circuit (e.g., a picker). In one example, a picker implemented in one of those cores can identify a pair of vector micro-operations that are eligible for consolidation. For example, the picker can identify vector micro-operations located within a certain number of positions from one another in the queue. In this example, the picker can check whether those micro-operations satisfy one or more criteria indicative of their eligibility for consolidation.

On the one hand, if those micro-operations satisfy the criteria, the picker can consolidate those micro-operations into a single vector micro-operation and then forward the same through the core's pipeline for execution. On the other hand, if those micro-operations do not satisfy the criteria, the picker can refuse to consolidate those micro-operations into a single vector micro-operation. For example, the picker can opt not to consolidate those micro-operations because they do not satisfy the criteria. Instead, the picker can simply forward those micro-operations separately and/or independently through the core's pipeline for execution.

As will be described in greater detail below, the instant disclosure generally relates to devices, systems, and methods for consolidating eligible vector instructions. In one example, a method for accomplishing such a task can include detecting a plurality of vector instructions within a storage feature of a processor. The method can also include consolidating the plurality of vector instructions into a single vector instruction due at least in part to the plurality of vector instructions satisfying one or more criteria. The method can further include forwarding the single vector instruction through a pipeline of the processor.

Similarly, a corresponding computing device can include a storage feature and at least one circuit configured to detect a plurality of vector instructions within the storage feature. In one example, the circuit can also be configured to consolidate the plurality of vector instructions into a single vector instruction due at least in part to the plurality of vector instructions satisfying one or more criteria. The circuit can be further configured to forward the single vector instruction through a pipeline.

In some examples, a corresponding system can include a storage feature, a pipeline, and at least one circuit configured to detect a plurality of vector instructions within the storage feature. In one example, the circuit can also be configured to consolidate the plurality of vector instructions into a single vector instruction due at least in part to the plurality of vector instructions satisfying one or more criteria. The circuit can be further configured to forward the single vector instruction through the pipeline.

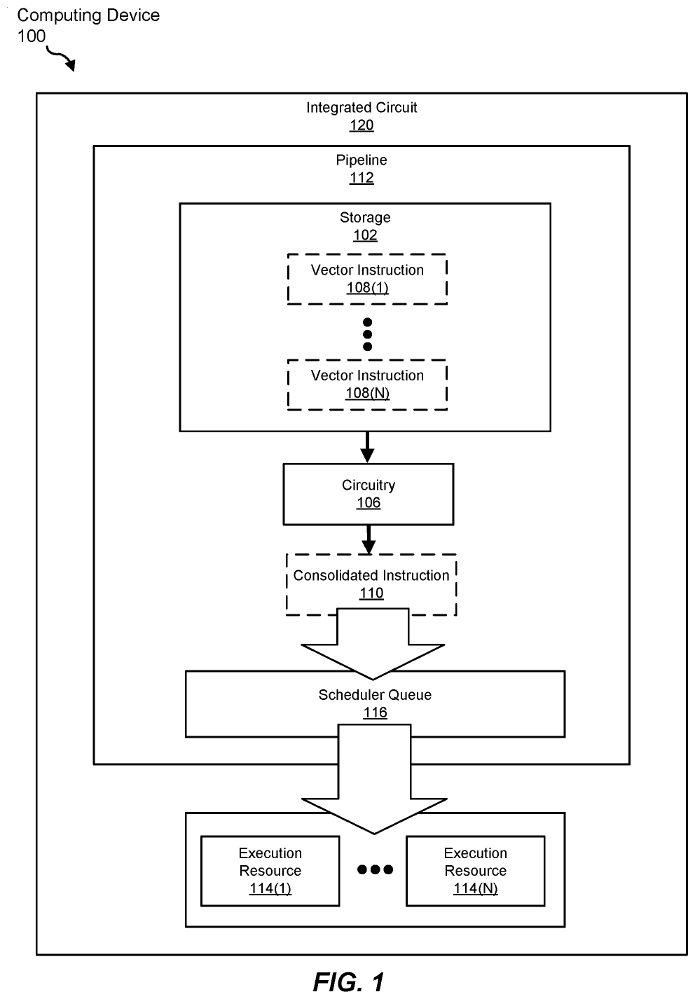

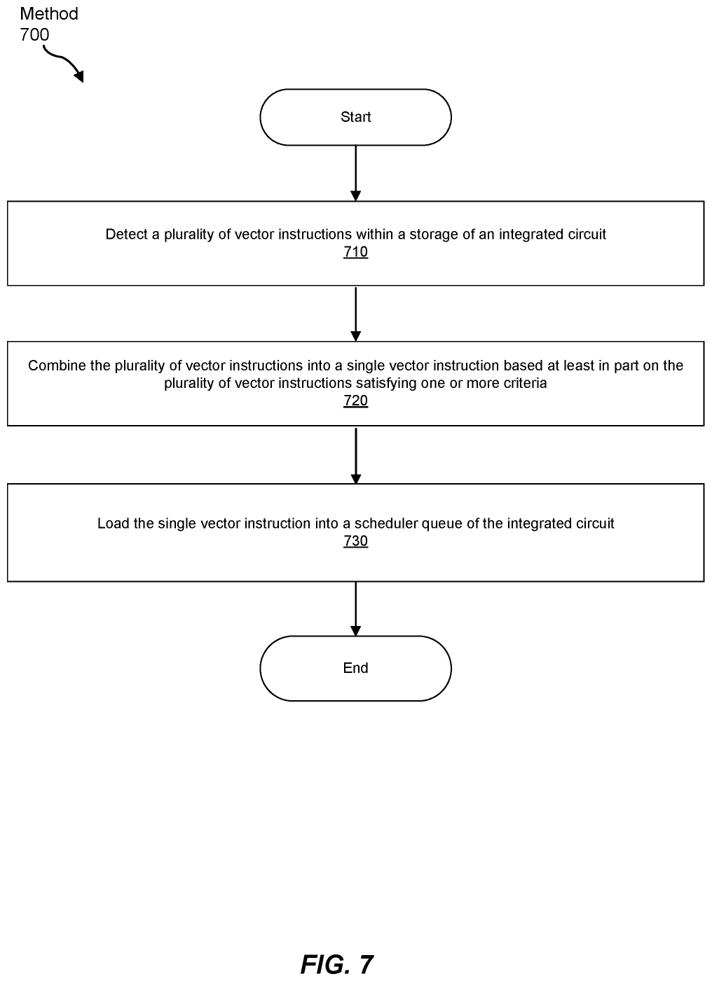

The following will provide, with reference to FIGS. 1-6, detailed descriptions of exemplary devices, systems, components, and/or corresponding implementations for consolidating eligible vector instructions. Detailed descriptions of an exemplary method for consolidating eligible vector instructions will be provided in connection with FIG. 7.

FIG. 1 shows an exemplary computing device 100 that facilitates consolidating eligible vector instructions. As illustrated in FIG. 1, computing device 100 can include and/or represent an integrated circuit 120 equipped with a pipeline 112 and/or execution resources 114(1)-(N). In some examples, pipeline 112 can facilitates and/or supports forwarding, passing, and/or sending vector instructions 108(1)-(N) toward execution resources 114(1)-(N). In one example, pipeline 112 can include and/or represent storage 102, a circuitry 106, and/or a scheduler queue 116.

In some examples, storage 102 can maintain, store, and/or buffer vector instructions 108(1)-(N) before they are passed and/or sent through pipeline 112 toward execution resources 114(1)-(N). In one example, storage 102 can include and/or represent a queue that maintains, stores, and/or buffers vector instructions 108(1)-(N) in an age-based order and/or a first in, first out (FIFO) order. Additionally or alternatively, storage 102 can include and/or represent a cache that maintains, stores, and/or organizes vector instructions 108(1)-(N) in accordance with a certain indexing scheme.

In some examples, circuitry 106 can be responsible for scheduling vector instructions 108(1)-(N) to be forwarded, passed, and/or loaded into a scheduler queue 116 on their way toward execution resources 114(1)-(N). For example, circuitry 106 can pick and/or select one or more of vector instructions 108(1)-(N) from storage 102. In one example, after having picked and/or selected one or more of vector instructions 108(1)-(N) from storage 102, circuitry 106 can forward, pass, and/or load the same into scheduler queue 116 on the way toward execution resources 114(1)-(N). Additional circuitry included in integrated circuit 120 and/or computing device 100 can receive, pick, select, and/or obtain vector instructions 108(1)-(N) from scheduler queue 116 and then forward, pass, and/or send vector instructions 108(1)-(N) to execution resources 114(1)-(N).

In some examples, integrated circuit 120 can include and/or represent a set of execution resources 114(1)-(N). In such examples, the set of execution resources 114(1)-(N) can include and/or represent one or more complex resources and/or one or more simple resources. In one example, complex resources can perform, compute, and/or execute vector instructions 108(1)-(N) (e.g., complex micro-operations) picked and/or selected by circuitry 106. In this example, simple resources can perform, compute, and/or execute vector instructions 108(1)-(N) (e.g., simple micro-operations) picked and/or selected by circuitry 106.

In certain examples, circuitry 106 can identify and/or detect some of vector instructions 108(1)-(N) within storage 102. For example, as one or more of vector instructions 108(1)-(N) reach the front of storage 102, circuitry 106 can check and/or examine such vector instructions for consolidation eligibility. To do so, circuitry 106 can determine and/or confirm whether some of vector instructions 108(1)-(N) satisfy one or more eligibility criteria, thereby making them consolidation candidates.

In one example, if vector instructions 108(1) and 108(N) satisfy the criteria, circuitry 106 can consolidate, combine, and/or fuse vector instructions 108(1) and 108(N) into a single consolidated instruction 110 that accounts for and/or represents both of vector instructions 108(1) and 108(N). In this example, circuitry 106 can then forward, pass, and/or send consolidated instruction 110 to scheduler queue 116 on the way to one or more of execution resources 114(1)-(N) via pipeline 112. Additional circuitry included in integrated circuit 120 and/or computing device 100 can receive, pick, select, and/or obtain consolidated instruction 110 from scheduler queue 116 and then forward, pass, and/or send consolidated instruction 110 to execution resources 114(1)-(N).

Continuing with this example, if vector instructions 108(1) and 108(N) do not satisfy the criteria, circuitry 106 can refuse to consolidate, combine, and/or fuse vector instructions 108(1) and 108(N) into a single consolidated vector instruction. For example, circuitry 106 can opt not to consolidate vector instructions 108(1) and 108(N) because they do not satisfy the criteria. Instead, circuitry 106 can then forward, pass, and/or load vector instructions 108(1) and 108(N) separately and/or independently into scheduler queue 116 on the way toward one or more of execution resources 114(1)-(N) via pipeline 112.

Various criteria can be applied and/or used to define eligibility for consolidating vector instructions 108(1)-(N). For example, the criteria can include and/or represent a requirement for a certain opcode pair and/or some of the same operands to be identified in eligible vector instructions. In one example, circuitry 106 can consolidate, combine, and/or fuse vector instructions 108(1) and 108(N) into consolidated instruction 110 due at least in part to such an opcode pair and/or some of the same operands being identified in vector instructions 108(1) and 108(N).

For example, vector instruction 108(1) can include and/or represent an opcode that sets a mask, and vector instruction 108(N) can include and/or represent another opcode that uses the mask. Examples of opcode pairs that can be eligible for consolidation include, without limitation, certain pairs of opcodes that represent shift and logical operations, a pair of opcodes that represent permute (e.g., copying contents of an array) and logical operations, certain pairs of opcodes that represent logical and arithmetic (e.g., add, subtract, multiple, and divide) operations, certain pairs of opcodes that both represent arithmetic operations, combinations or variations of one or more of the same, and/or any other suitable opcode pairs.

In another example, vector instruction 108(1) can include and/or represent one or more operands, and vector instruction 108(N) can include and/or represent some or all of the same operands. Examples of such operands include, without limitation, destinations, sources, registers, memory addresses, immediate values, constants, variables, pointers, combinations or variations of one or more of the same, and/or any other suitable operands.

Additionally or alternatively, the criteria can include and/or represent a requirement for a match between an eligibility filter and a bit string included in an opcode of one or more eligible vector instructions. In one example, circuitry 106 can consolidate, combine, and/or fuse vector instructions 108(1) and 108(N) into consolidated instruction 110 due at least in part to such a match between an eligibility filter and a bit string included in an opcode of at least one of vector instructions 108(1) and 108(N). In certain implementations, the eligibility filter can define and/or identify a feature (such as a specific portion of an opcode and/or a bit string) that, if found in vector instructions 108(1) and 108(N), qualifies vector instructions 108(1) and 108(N) for consolidation.

Additionally or alternatively, the criteria can include and/or represent a requirement for a certain output rendered by a logic operation performed on a first portion of an opcode included in one or more eligible vector instructions and an input found in a lookup table indexed by a second portion of the opcode. In one example, circuitry 106 can consolidate, combine, and/or fuse vector instructions 108(1) and 108(N) into consolidated instruction 110 due at least in part to such an output being rendered by a logic operation. In this example, the logic operation can involve and/or use a first potion of an opcode from vector instruction 108(1) or 108(N) as one input and data found in a lookup table indexed by a second portion of the opcode as another input.

Additionally or alternatively, the criteria can include and/or represent a requirement for eligible vector instructions to be positioned within a certain number of instructions from one another within storage 102. As a specific example, to be eligible for consolidation, vector instructions need to be positioned either adjacent to one another and/or within three, four, five, etc., slots of one another in the instruction stream. In one example, circuitry 106 can consolidate, combine, and/or fuse vector instructions 108(1) and 108(N) into consolidated instruction 110 due at least in part to vector instructions 108(1) and 108(N) being positioned within a certain number of instructions from one another within storage 102.

Additionally or alternatively, the criteria can include and/or represent a requirement for eligible vector instructions to be capable of consolidating into a single vector instruction that complies with certain constraints. In one example, circuitry 106 can consolidate, combine, and/or fuse vector instructions 108(1) and 108(N) into consolidated instruction 110 due at least in part to vector instructions 108(1) and 108(N) being capable of consolidating into a single vector instruction that complies with such constraints. Examples of such constraints include, without limitation, no more than one destination operand included in the single vector instruction, no more than three source operands included in the single vector instruction, no more than one immediate value included in the single vector instruction, no more than one mask register included in the single vector instruction, combinations or variations of one or more of the same, and/or any other suitable constraints.

In some examples, circuitry 106 can monitor, screen, and/or scan the instruction stream at storage 102. For example, circuitry 106 can monitor, screen, and/or scan a queue in the critical path and/or a cache outside the critical path for consolidation candidates. In one example, circuitry 106 can search the instruction stream for a vector instruction that sets the value of a mask register (sometimes also referred to as a k-register) based on a condition and/or test. In this example, upon finding such a vector instruction, circuitry 106 can check whether a subsequent instruction in the instruction stream uses that mask register value as a bit mask while performing an operation across all elements of a vector. Accordingly, vector instructions that create a mask and then subsequently use that mask can be eligible for consolidation.

As a specific example, circuitry 106 can identify and/or detect adjacent vector instructions within storage 102. In this example, circuitry 106 can identify and/or detect a mask register as the destination of the first of those adjacent vector instructions. In response to identifying and/or detecting the mask register as the destination of the first of those adjacent vector instructions, circuitry 106 can check and/or examine whether the next of those adjacent vector instructions satisfies one or more of the eligibility criteria (e.g., using a mask register number and/or a mask register identifier).

In some examples, integrated circuit 120 can include and/or represent any type or form of hardware device capable of interpreting and/or executing computer-readable instructions. In one example, integrated circuit 120 can include and/or represent one or more semiconductor devices implemented and/or deployed as part of a computing system. For example, integrated circuit 120 can include and/or represent a processor and/or a core. More specifically, integrated circuit 120 can include and/or represent a vector processor and/or a core included in a vector processor. In this example, such a vector processor can implement and/or execute vector instructions 108(1)-(N) to operate on large one-dimensional arrays of data that are sometimes referred to as vectors. In certain implementations, such a vector processor differs from scalar processors because they operate on single data objects. Additional examples of integrated circuit 120 include, without limitation, central processing units (CPUs), graphics processing units (GPUs), microprocessors, microcontrollers, field-programmable gate arrays (FPGAs), application-specific integrated circuits (ASICs), systems on a chip (SoCs), accelerated processing units (APUs), portions of one or more of the same, variations or combinations of one or more of the same, and/or any other suitable computing device.

In some examples, computing device 100 can include and/or represent a personal computer. Additional examples of computing device 100 include, without limitation, client devices, laptops, tablets, desktops, servers, cellular phones, Personal Digital Assistants (PDAs), multimedia players, embedded systems, wearable devices, gaming consoles, routers, switches, hubs, modems, bridges, repeaters, gateways, multiplexers, network adapters, network interfaces, portions of one or more of the same, variations or combinations of one or more of the same, and/or any other suitable computing device.

Integrated circuit 120 and/or computing device 100 can implement and/or be configured with any of a variety of different architectures and/or microarchitectures. For example, integrated circuit 120 and/or computing device 100 can implement and/or be configured as a reduced instruction set computer (RISC) architecture. In another example, integrated circuit 120 and/or computing device 100 can implement and/or be configured as a complex instruction set computer (CISC) architecture. Additional examples of such architectures and/or microarchitectures include, without limitation, 16-bit computer architectures, 32-bit computer architectures, 64-bit computer architectures, x86 computer architectures, advanced RISC machine (ARM) architectures, microprocessor without interlocked pipelined stages (MIPS) architectures, scalable processor architectures (SPARCs), load-store architectures, portions of one or more of the same, combinations or variations of one or more of the same, and/or any other suitable architectures or microarchitectures.

In some examples, storage 102 can include and/or represent any type or form of queue (e.g., a scheduler queue) and/or buffer implemented and/or configured in computing device 100. In one example, storage 102 can include and/or represent a data structure and/or an abstract data type. For example, storage 102 can include and/or represent a queue. In another example, storage 102 can include and/or represent a portion of a CPU that maintains, presents, and/or provides vector instructions 108(1)-(N) to be picked and/or selected for feeding and/or issuance to execution resources 114(1)-(N). In a further example, storage 102 can include and/or represent a cache that stores and/or maintains vector instructions 108(1)-(N) outside and/or off the critical path. Additionally or alternatively, storage 102 can include and/or represent hardware, software, and/or firmware implemented as part of computing device 100.

In some examples, circuitry 106 can include and/or represent any type or form of circuitry (e.g., a picker, a fuser, an unfuser, and/or a scheduler) that picks and/or selects vector instructions 108(1)-(N) for execution by execution resources 114(1)-(N). For example, circuitry 106 can include and/or represent a fusion unit and/or logic configured to consolidate eligible pairs of vector instructions 108(1)-(N) that satisfy one or more criteria prior to reaching scheduler queue 116 in pipeline 112. In this example, each consolidation can produce and/or result in a single vector instruction that combines and/or accounts for a pair of vector instructions 108(1)-(N).

In some examples, circuitry 106 can pick and/or select a certain number of vector instructions 108(1)-(N) and/or non-vector instructions (e.g., scalar instructions) as a pick that is issued for traversal through pipeline 112 toward execution resources 114(1)-(N). In one example, the pick can include and/or represent any combination of vector, complex, scalar, and/or simple instructions or micro-operations that correspond to and/or comply with the configuration of execution resources 114(1)-(N). In certain implementations, circuitry 106 can include and/or represent hardware incorporated in computing device 100. For example, circuitry 106 can include and/or represent one or more digital logic gates (e.g., AND gates, OR gates, NAND gates, NOR gates, XOR gates, and/or XNOR gates) that perform logic operations and/or comparisons on data included in vector instructions 108(1)-(N). Additionally or alternatively, circuitry 106 can include and/or represent hardware that executes and/or implements certain firmware and/or software. In certain implementations, circuitry 106 can include and/or represent a fusion unit and/or logic responsible for consolidating and/or fusing eligible micro-operations and an accounting unit and/or logic responsible for separating and/or accounting for the consolidated and/or fused micro-operations.

In some examples, execution resources 114(1)-(N) can include and/or represent any type or form of digital circuit that performs and/or executes vector, complex, scalar, and/or simple instructions or micro-operations on numbers, data, and/or values. In one example, executive resources 114(1)-(N) can include and/or represent simple resources like arithmetic logic units (ALUs) capable of executing simple instructions or micro-operations (such as addition, subtraction, and/or comparison operations). Additionally or alternatively, execution resources 114(1)-(N) can include and/or represent complex resources like binary multipliers, vector units, and/or floating point units (FPUs) capable of executing certain vector and/or complex instructions or micro-operations (such as multiplication, division, and/or floating-point operations). Additionally or alternatively, execution resources 114(1)-(N) can include and/or represent any other type of resource (e.g., a complex ALU) capable of executing such vector and/or complex instructions or micro-operations.

In some examples, vector instructions 108(1)-(N) can each include and/or represent any type or form of vector-type code and/or instruction performed and/or executed by execution resources 114(1)-(N) of integrated circuit 120. In one example, vector instructions 108(1)-(N) can include and/or represent one or more complex and/or special micro-operations (such as multiplication, division, floating-point, mask, load, shift, and/or logical operations). Additionally or alternatively, vector instructions 108(1)-(N) can include and/or represent one or more extensions to the x86 instruction set architecture, such as Advanced Vector Extensions (AVX) or the like. For example, vector instructions 108(1)-(N) can include and/or represent AVX instructions or micro-operations. Further, vector instructions 108(1)-(N) can include and/or represent single instruction, multiple data (SIMD) instructions and/or micro-operations or the like. Vector instructions 108(1)-(N) can also involve and/or represent vector-based updates to registers, vector-based data transfers to or between registers, and/or vector-based data transfers from interfaces (e.g., buses) to registers or vice versa.

In some examples, consolidated instruction 110 can include and/or represent any type or form of vector-type code and/or instruction that results from the consolidation of multiple vector instructions. In one example, consolidated instruction 110 can include and/or represent sufficient code, data, and/or information to account for both of vector instructions 108(1) and 108(N). For example, consolidated instruction 110 can include and/or represent an amalgamation of information capable of being split and/or separated after passing through pipeline 112 to restore vector instructions 108(1) and 108(N) for execution by one or more of execution resources 114(1)-(N). Additionally or alternatively, consolidated instruction 110 can include and/or represent an amalgamation of information capable of causing one or more of execution resources 114(1)-(N) to achieve and/or produce the same outcome and/or result as vector instructions 108(1) and 108(N) despite never being split and/or separated after passing through pipeline 112. Accordingly, in certain implementations, execution resources 114(1)-(N) can be configured and/or programmed to interpret and/or execute consolidated instruction 110 without the need for separating and/or reconstructing vector instructions 108(1) and 108(N).

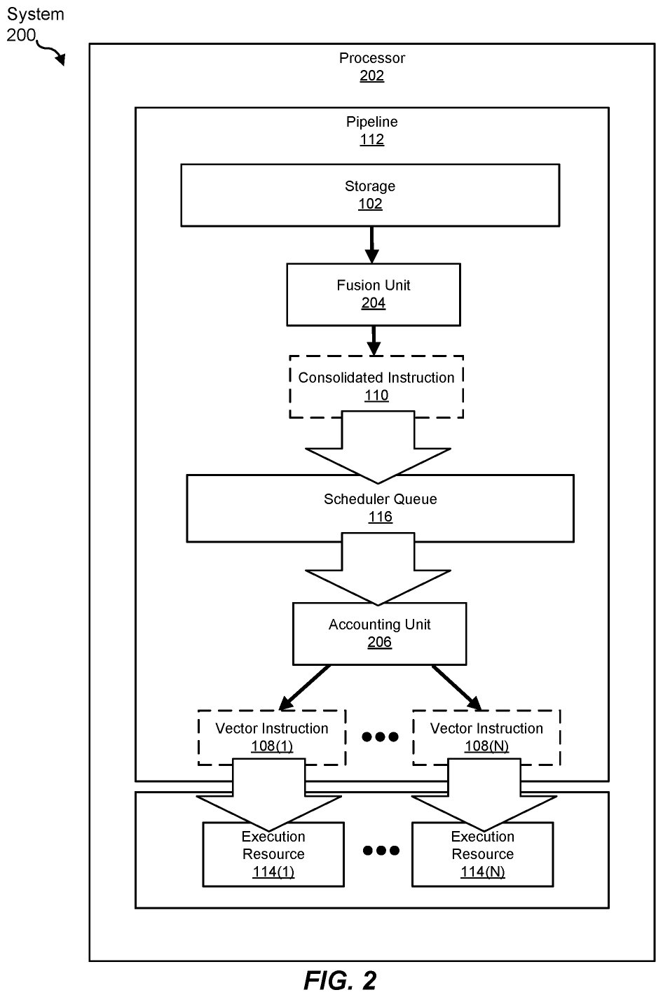

FIG. 2 illustrates an exemplary system 200 that facilitates consolidating eligible vector instructions. In some examples, system 200 can include and/or represent certain components and/or features that perform and/or provide functionalities that are similar and/or identical to those described above in connection with FIG. 1. As illustrated in FIG. 2, in addition to those components and/or features described above in connection with computing device 100 of FIG. 1, system 200 can additionally or alternatively include and/or represent a processor 202, fusion unit 204, and accounting unit 206. In one example, processor 202 of system 200 can include and/or represent storage 102, circuitry 106, pipeline 112, and/or execution resources 114(1)-(N).

In some examples, fusion unit 204 can consolidate, combine, and/or fuse a plurality of vector instructions 108(1)-(N) into consolidated instruction 110. Additionally or alternatively, accounting unit 206 can decode, split, unfuse, and/or separate consolidated instruction 110 into the corresponding vector instructions. In one example, the vector instructions split and/or separated from consolidated instruction 110 can be fed and/or delivered to one or more of execution resources 114(1)-(N). Execution resources 114(1)-(N) can then execute, implement, and/or perform those vector instructions. In other examples, execution resources 114(1)-(N) can be configured and/or programmed to interpret and/or execute consolidated instruction 110 to achieve and/or produce the same outcome and/or result as the plurality of vector instructions 108(1)-(N) without the need for separating and/or reconstructing vector instructions 108(1) and 108(N).

In some examples, circuitry 106, execution resources 114(1)-(N), and/or another component of system 200 can modify and/or increase a retirement count to account for the execution of the plurality of vector instructions 108(1)-(N) even though only consolidated instruction 110 traversed and/or passed through pipeline 112. In one example, the retirement count can represent the number of vector instructions 108(1)-(N) that have been executed by execution resources 114(1)-(N). Additionally or alternatively, the retirement count can indicate the number of vector instructions 108(1)-(N) executed by execution resources 114(1)-(N) relative to the number of vector instructions 108(1)-(N) issued by circuitry 106. For example, the retirement count can represent the difference between the number of vector instructions 108(1)-(N) issued by circuitry 106 and the number of vector instructions 108(1)-(N) executed by execution resources 114(1)-(N).

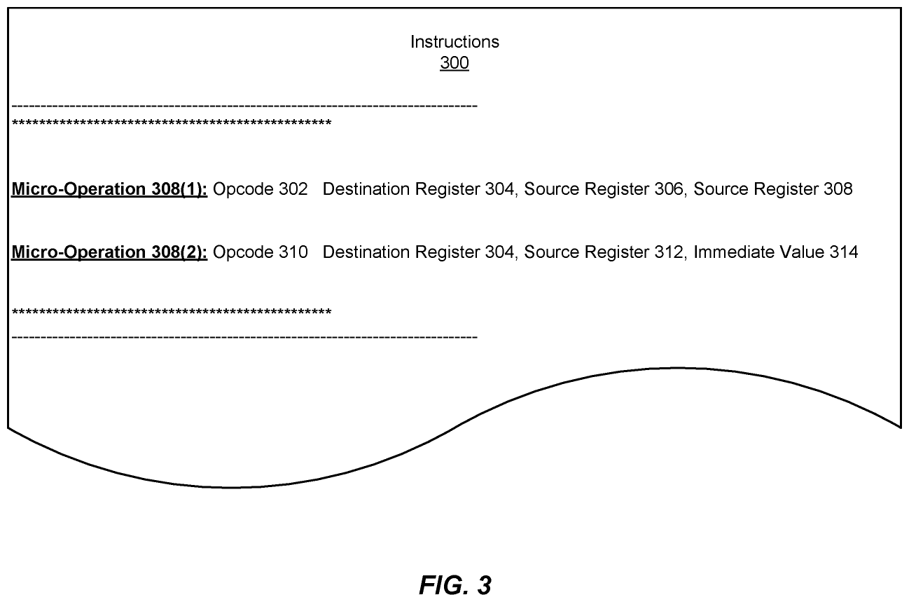

FIG. 3 illustrates exemplary instructions 300 that include and/or represent micro-operations 308(1) and 308(2). In some examples, instructions 300 can be considered and/or examined for consolidation eligibility. In one example, instructions 300 can be formatted in different ways depending on their opcodes. For example, micro-operation 308(1) can include and/or represent an opcode 302, a destination register 304, a source register 306, and a source register 308. In this example, micro-operation 308(2) can include and/or represent an opcode 310, a destination register 304, a source register 312, and an immediate value 314.

As a specific example, circuitry 106 can check and/or examine whether micro-operations 308(1) and 308(2) are eligible for consolidation. In this example, during the check and/or examination, circuitry 106 can identify and/or confirm that opcodes 302 and 310 constitute a compatible and/or eligible pair of opcodes. For example, circuitry 106 can generate, produce, and/or output data indicating that opcode 302 sets a mask and opcode 310 uses that mask. Additionally or alternatively, during the check and/or examination, circuitry 106 can identify and/or confirm that destination register 304 is an operand included in both of micro-operations 308(1) and 308(2). Micro-operations 308(1) and 308(2) can be adjacent to one another and/or within one or more positions of one another within storage 102. Circuitry 106 can then determine and/or confirm that micro-operations 308(1) and 308(2) are eligible for consolidation based at least in part on one or more of these features.

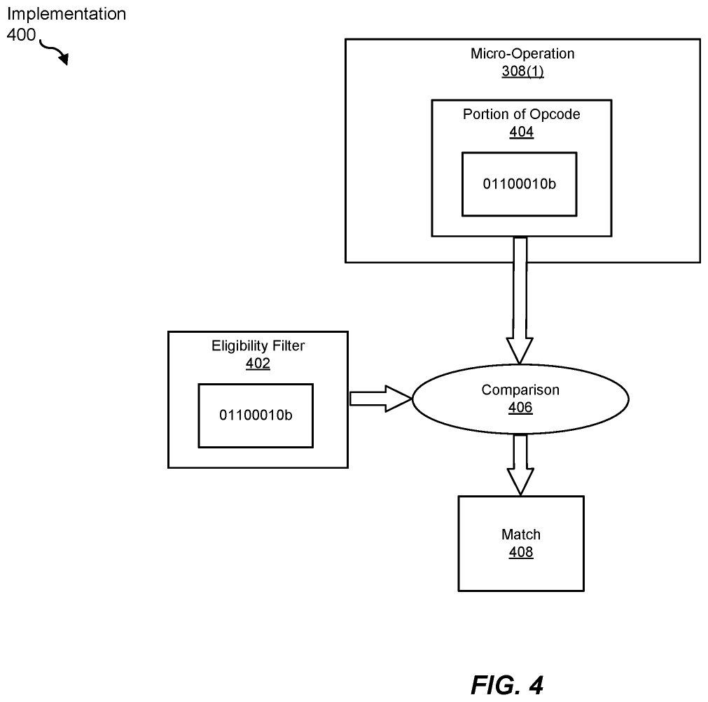

FIG. 4 illustrates an exemplary implementation 400 that facilitates consolidating eligible vector instructions. In some examples, implementation 400 can include and/or represent certain components and/or features that perform and/or provide functionalities that are similar and/or identical to those described above in connection with any of FIGS. 1-3. As illustrated in FIG. 4, exemplary implementation 400 can involve a comparison 406 between an eligibility filter 402 and a portion of opcode 404 in micro-operation 308(1). In one example, circuitry 106 can perform comparison 406 to determine and/or confirm whether micro-operation 308(1) is eligible for consolidation with another micro-operation within a certain number of positions in storage 102. For example, circuitry 106 can perform comparison 406 by executing a logic operation on “01100010b” from portion of opcode 404 and “01100010b” from eligibility filter 402. In this example, circuitry 106 can render and/or produce a match 408 via comparison 406.

In some examples, match 408 can indicate that micro-operation 308(1) is potentially eligible for consolidation with a subsequent vector micro-operation. In response to match 408, circuitry 106 can search storage 102 for a subsequent vector micro-operation that qualifies for consolidation with micro-operation 308(1). For example, circuitry 106 can check and/or examine adjacent micro-operation 308(2) to determine whether micro-operation 308(2) satisfies one or more criteria indicative of eligibility for consolidation with micro-operation 308(1). In this example, if micro-operation 308(2) satisfies the criteria, circuitry 106 can consolidate micro-operations 308(1) and 308(2) into consolidated instruction 110. However, if micro-operation 308(2) does not satisfy the criteria, circuitry 106 can check and/or examine the next vector micro-operation in storage 102 to determine whether that vector micro-operation satisfies the criteria indicative of eligibility for consolidation with micro-operation 308(1).

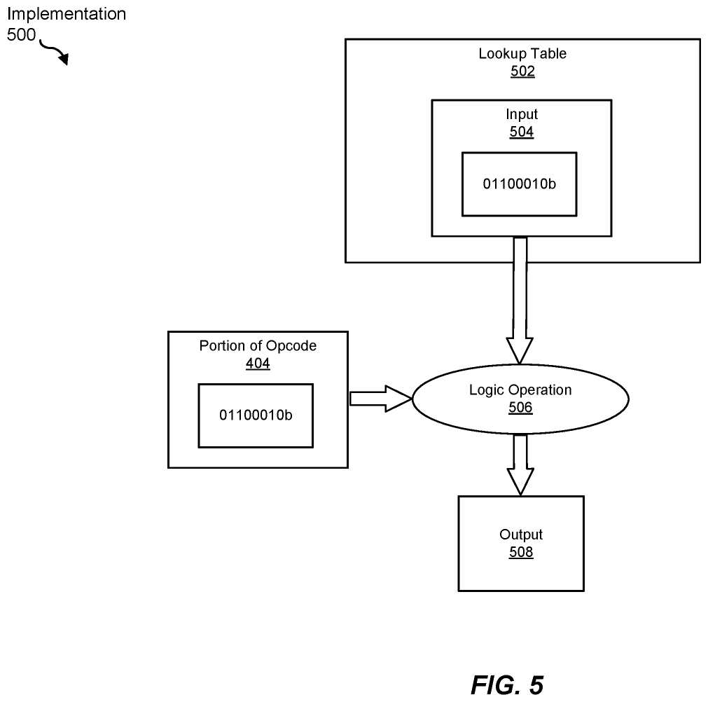

FIG. 5 illustrates an exemplary implementation 500 that facilitates consolidating eligible vector instructions. In some examples, implementation 500 can include and/or represent certain components and/or features that perform and/or provide functionalities that are similar and/or identical to those described above in connection with any of FIGS. 1-4. As illustrated in FIG. 5, exemplary implementation 500 can involve a logic operation 506 that renders and/or produces an output 508 based at least in part on an input 504 and portion of opcode 404. In one example, integrated circuit 120 can include and/or represent a lookup table 502 indexed by another portion of the opcode in micro-operation 308(1). In this example, circuitry 106 can search lookup table 502 for input 504 by using this other portion of the opcode as a lookup and/or database key.

During this search, circuitry 106 can find and/or locate input 504 to be used as one of the inputs for logic operation 506. In one example, circuitry 106 can perform and/or execute logic operation 506 to render and/or produce output 508, which indicates that micro-operation 308(1) is eligible for consolidation with a subsequent micro-operation. In response to output 508, circuitry 106 can search storage 102 for a subsequent vector micro-operation that qualifies for consolidation with micro-operation 308(1). For example, circuitry 106 can check and/or examine adjacent vector micro-operation 308(2) to determine whether vector micro-operation 308(2) satisfies one or more criteria indicative of eligibility for consolidation with vector micro-operation 308(1). In this example, if micro-operation 308(2) satisfies the criteria, circuitry 106 can consolidate vector micro-operations 308(1) and 308(2) into consolidated instruction 110. However, if micro-operation 308(2) does not satisfy the criteria, circuitry 106 can check and/or examine the next vector micro-operation in storage 102 to determine whether that vector micro-operation satisfies the criteria indicative of eligibility for consolidation with micro-operation 308(1).

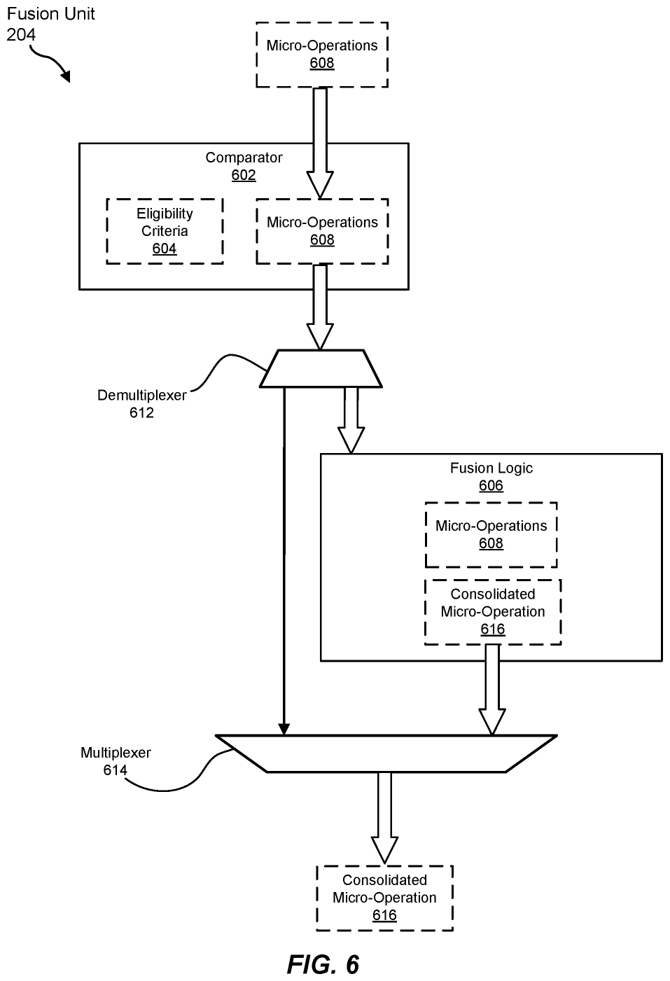

FIG. 6 illustrates an exemplary implementation of fusion unit 204 that consolidates and/or fuses eligible vector micro-operations. In some examples, fusion unit 204 can include and/or represent certain components and/or features that perform and/or provide functionalities that are similar and/or identical to those described above in connection with any of FIGS. 1-5. As illustrated in FIG. 6, exemplary fusion unit 204 can include and/or represent a comparator 602, a demultiplexer 612, fusion logic 606, and/or a multiplexer 614. In one example, comparator 602 can receive, obtain, and/or detect micro-operations 608 from storage 102. In this example, comparator 602 can compare micro-operations 608 to eligibility criteria 604. If the comparison indicates that micro-operations 608 are eligible for consolidation, comparator 602 can forward and/or send micro-operations 608 to fusion logic 606 via demultiplexer 612 for consolidation. Alternatively, if the comparison indicates that micro-operations 608 are ineligible for consolidation, comparator 602 can forward and/or send micro-operations 608 to multiplexer 614 via demultiplexer 612.

In some examples, fusion logic 606 can consolidate and/or fuse micro-operations 608 into a consolidated micro-operation 616 due at least in part to micro-operations 608 having satisfied eligibility criteria 604. In one example, fusion logic 606 can forward and/or send consolidated micro-operation 616 to scheduler queue 116 via multiplexer 614. Upon selection for execution, consolidated micro-operation 616 can continue down pipeline 112 toward execution resources 114(1)-(N).

In some examples, the various devices and/or systems described in connection with FIGS. 1-6 can include and/or represent one or more additional circuits, components, and/or features that are not necessarily illustrated and/or labeled in FIGS. 1-6. For example, computing device 100, integrated circuit 120, and/or system 200 can also include and/or represent additional analog and/or digital circuitry, onboard logic, transistors, resistors, capacitors, diodes, inductors, switches, registers, flipflops, connections, traces, buses, semiconductor (e.g., silicon) devices and/or structures, processing devices, storage devices, circuit boards, packages, substrates, housings, combinations or variations of one or more of the same, and/or any other suitable components that facilitate and/or support consolidating eligible vector instructions. In certain implementations, one or more of these additional circuits, components, devices, and/or features can be inserted and/or applied between any of the existing circuits, components, and/or devices illustrated in FIGS. 1-6 consistent with the aims and/or objectives provided herein. Accordingly, the electrical and/or communicative couplings described with reference to FIGS. 1-6 can be direct connections with no intermediate components, devices, and/or nodes or indirect connections with one or more intermediate components, devices, and/or nodes.

In some examples, the phrase “to couple” and/or the term “coupling”, as used herein, can refer to a direct connection and/or an indirect connection. For example, a direct coupling between two components can constitute and/or represent a coupling in which those two components are directly connected to each other by a single node that provides electrical continuity from one of those two components to the other. In other words, the direct coupling can exclude and/or omit any additional components between those two components.

Additionally or alternatively, an indirect coupling between two components can constitute and/or represent a coupling in which those two components are indirectly connected to each other by multiple nodes that fail to provide electrical continuity from one of those two components to the other. In other words, the indirect coupling can include and/or incorporate at least one additional component between those two components.

FIG. 7 is a flow diagram of an exemplary method 700 for consolidating eligible vector instructions. In one example, the steps shown in FIG. 7 can be performed by one or more components of a processor incorporated into a computing device. Additionally or alternatively, the steps shown in FIG. 7 can also incorporate and/or involve various sub-steps and/or variations consistent with the descriptions provided above in connection with FIGS. 1-6.

As illustrated in FIG. 7, method 700 can include and/or involve the step of detecting a plurality of vector instructions within a queue of a processor (710). Step 710 can be performed in a variety of ways, including any of those described above in connection with FIGS. 1-6. For example, a circuit included in a core of a processor can detect a plurality of vector instructions within a queue of a processor.

Method 700 can also include the step of consolidating the plurality of vector instructions into a single vector instruction due at least in part to the plurality of vector instructions satisfying one or more criteria (720). Step 720 can be performed in a variety of ways, including any of those described above in connection with FIGS. 1-6. For example, the circuit included in the core of the processor can consolidate the plurality of vector instructions into a single vector instruction due at least in part to the plurality of vector instructions satisfying one or more criteria.

Method 700 can further include the step of forwarding the single vector instruction through a pipeline of the processor (730). Step 730 can be performed in a variety of ways, including any of those described above in connection with FIGS. 1-6. For example, the circuit included in the core of the processor can forward the single vector instruction through a pipeline of the processor toward one or more execution resources.

While the foregoing disclosure sets forth various embodiments using specific block diagrams, flowcharts, and examples, each block diagram component, flowchart step, operation, and/or component described and/or illustrated herein can be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

The devices, systems, and methods described herein can employ any number of software, firmware, and/or hardware configurations. For example, one or more of the exemplary embodiments and/or implementations disclosed herein can be encoded as a computer program (also referred to as computer software, software applications, computer-readable instructions, and/or computer control logic) on a non-transitory computer-readable medium. In one example, when executed by at least one processor, the encodings of the computer-readable medium can cause the processor to generate and/or produce a computer-readable representation of an integrated circuit configured to do, perform, and/or execute any of the tasks, features, and/or actions described herein in connection with FIGS. 1-6. The term “computer-readable medium” generally refers to any form of non-transitory device, carrier, or medium capable of storing or carrying computer-readable instructions. Examples of computer-readable media include, without limitation, non-transitory-type media, magnetic-storage media (e.g., hard disk drives and floppy disks), optical-storage media (e.g., Compact Disks (CDs) and Digital Video Disks (DVDs)), electronic-storage media (e.g., solid-state drives and flash media), and/or other any other suitable computer-readable media.

In addition, one or more of the modules, instructions, and/or micro-operations described herein can transform data, physical devices, and/or representations of physical devices from one form to another. Additionally or alternatively, one or more of the modules, instructions, and/or micro-operations described herein can transform a processor, volatile memory, non-volatile memory, and/or any other portion of a physical computing device from one form to another by executing on the computing device, storing data on the computing device, and/or otherwise interacting with the computing device.

The process parameters and sequence of the steps described and/or illustrated herein are given by way of example only and can be varied as desired. For example, while the steps illustrated and/or described herein can be shown or discussed in a particular order, these steps do not necessarily need to be performed in the order illustrated or discussed. The various exemplary methods described and/or illustrated herein can also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A method comprising:
detecting a plurality of vector instructions within a storage of an integrated circuit;
consolidating the plurality of vector instructions into a single vector instruction based at least in part on the plurality of vector instructions satisfying one or more criteria; and
loading the single vector instruction into a scheduler queue of the integrated circuit.

2. The method of claim 1, further comprising:
receiving the single vector instruction from the scheduler queue;
restoring the plurality of vector instructions from the single vector instruction; and
executing the plurality of vector instructions via at least one execution resource of the integrated circuit.

3. The method of claim 2, wherein the at least one execution resource comprises at least one:
a binary multiplier;
a vector unit; or
a floating point unit.

4. The method of claim 2, further comprising modifying a retirement count to account for the execution of the plurality of vector instructions.

5. The method of claim 1, wherein:
the one or more criteria comprises an opcode pair identified in the plurality of vector instructions being eligible for consolidation; and
consolidating the plurality of vector instructions into the single vector instruction comprises consolidating the plurality of vector instructions into the single vector instruction based at least in part on the certain opcode pair being eligible for consolidation.

6. The method of claim 1, wherein:
the one or more criteria comprises a match between an eligibility filter and a bit string included in an opcode of at least one of the plurality of vector instructions; and
consolidating the plurality of vector instructions into the single vector instruction comprises consolidating the plurality of vector instructions into the single vector instruction based at least in part on the match between the eligibility filter and the bit string included in the opcode.

7. The method of claim 1, wherein:
the one or more criteria comprises an output rendered by a logic operation performed on a first portion of an opcode included in one or more of the plurality of vector instructions and an input found in a lookup table indexed by a second portion of the opcode; and
consolidating the plurality of vector instructions into the single vector instruction comprises consolidating the plurality of vector instructions into the single vector instruction based at least in part on the logic operation rendering the output.

8. The method of claim 1, wherein:
the one or more criteria comprises the plurality of vector instructions being positioned within a certain number of instructions from one another in the storage; and
consolidating the plurality of vector instructions into the single vector instruction comprises consolidating the plurality of vector instructions into the single vector instruction based at least in part on the plurality of vector instructions being positioned within the certain number of instructions from one another in the storage.

9. The method of claim 1, wherein the storage comprises at least one of:
a queue; or
a cache.

10. The method of claim 1, wherein the single vector instruction complies with one or more constraints, the one or more constraints comprising at least one of:
no more than one destination operand is included in the single vector instruction;
no more than three source operands are included in the single vector instruction;
no more than one immediate value is included in the single vector instruction; or
no more than one mask register is included in the single vector instruction.

11. The method of claim 1, wherein the plurality of vector instructions comprises a first vector instruction and a second vector instruction that is positioned adjacent to the first vector instruction in the storage;
further comprising:
identifying a mask register as a destination of the first vector instruction; and
in response to identifying the mask register as the destination of the first vector instruction, checking whether the second vector instruction satisfies the one or more criteria; and
consolidating the plurality of vector instructions into the single vector instruction comprises consolidating the first vector instruction and the second vector instruction into the single vector instruction based at least in part on the second vector instruction satisfying the one or more criteria.

12. The method of claim 1, further comprising:
identifying a destination other than a mask register in an additional vector instruction within the storage; and
refusing to consolidate the additional vector instruction with a next instruction positioned adjacent to the additional vector instruction in the storage based at least in part on the destination not being a mask register.

13. The method of claim 1, further comprising:
receiving the single vector instruction from the scheduler queue; and
executing the single vector instruction via at least one execution resource of the integrated circuit.

14. The method of claim 1, wherein the plurality of vector instructions comprise one or more micro-operations that are eligible for consolidation into a single micro-operation.

15. A computing device comprising:
a storage; and
circuitry configured to:
detect a plurality of vector instructions within the storage;
consolidate the plurality of vector instructions into a single vector instruction based at least in part on the plurality of vector instructions satisfying one or more criteria; and
load the single vector instruction into a scheduler queue.

16. The computing device of claim 15, wherein the circuitry is further configured to:
receive the single vector instruction from the scheduler queue;
restore the plurality of vector instructions from the single vector instruction; and
execute the plurality of vector instructions via at least one execution resource.

17. The computing device of claim 16, wherein the at least one execution resource comprises at least one:
a binary multiplier;
a vector unit; or
a floating point unit.

18. The computing device of claim 16, wherein the circuitry is further configured to modify a retirement count to account for the execution of the plurality of vector instructions.

19. The computing device of claim 15, wherein:
the one or more criteria comprises a certain opcode pair identified in the plurality of vector instructions being eligible for consolidation; and
the circuitry is further configured to consolidate the plurality of vector instructions into the single vector instruction based at least in part on the certain opcode pair being eligible for consolidation.

20. A system comprising:
a storage;
a pipeline; and
circuitry configured to:
detect a plurality of vector instructions within the storage;
consolidate the plurality of vector instructions into a single vector instruction based at least in part on the plurality of vector instructions satisfying one or more criteria; and
load the single vector instruction into a scheduler queue.
